(19) United States
(12) Patent Application Publication
(10) Pub. No.: US 2006/0176189 A1
(43) Pub. Date: Aug. 10, 2006

(54) Two Dimensional Layout, High Noise Immunity, Interleaved Channels Electrostatic Encoder

(76) Inventor: David Bar-On, Givat Ella (IL)

Correspondence Address: Dr.David Bar-On, 5 Massada St., Givat Ella, 23800, IL

(21) Appl. No.: 10/906,174

(22) Filed: Feb. 6, 2005

(51) Int. Cl. G08C 19/10

(52) U.S. Cl. 340/870.37

(57) ABSTRACT

The present invention relates to an electrostatic capacity type encoder which includes a variable capacitance mechanism made on two dimensional planes, random time varying excitation generation system, interlaced fine & coarse cycles and digital signal processing unit. A variable capacitance mechanism which includes stationary and rotating disks facing each other and forming one or more variable capacitors. The transmit electrodes are split to two transmit phases and the receive electrodes to two receive phases, both can be implemented on two dimensional printed circuit boards without third dimension via interconnects. The combination of the 2 by 2 grid provides the four combinations required to detect both position and direction. Another configuration is made of electrostatic capacity type encoder which includes a first and second stationary disks and in between a third rotating disk, made either of a dielectric material with varying geometry or thickness or from a conductive patterns printed on a PCB. A time varying excitation system with no fundamental frequency is described to improve the robustness to external noise and omit the necessacity of excessive shielding. Interlacing mechanism is explained to put several different encoders channels on the same perimeter, minimizing encoder mechanical dimensions. To complete the sensor a digital signal processing unit is presented, where the capacitance value is converted to conventional encoder formats.

### FIELD OF THE INVENTION

The present invention relates to an electrostatic capacity type encoder, and more particularly to an improvement of the electrostatic capacity type encoder which electrically detects relative rotary displacement between rotary disks, or linear displacement between two components.

### PRIOR ART

In the prior art exists several measuring apparatus using an encoder which converts the displacement of a rotor moving along three distinctive transmitter plates referred as R, S, T or four distinctive transmitter plates referred as F1, F2, F3, F4. The implementation of three or more distinctive plates required three dimensional PCB design with one via interconnection per plate as in U.S. Pat. No. 2,534,505 and U.S. Pat. No. 4,788,546. As capacitive signal is highly prune to external interference, external shielding was suggested in U.S. Pat. No. 5,099,386. In U.S. Pat. No. 6,492,911 a labyrinth was added to further block interference from entering the sensor through the shaft. A cost effective noise rejecting mechanism using differential signals and differential amplifier was introduced in U.S. Pat. No. 3,93,8113, automatic gain control using a second reference channel was introduced in U.S. Pat. No. 4,864,295 to avoid the signal level degradation due to distance changes. In dialectic based transmittive rotors, where the rotor changes the dialectic constant when rotating, a two dimensional rotor structure was used, in U.S. Pat. No. 6,788,220 two such structures were placed one inside the other, making the plastic molding complicated and the rotor teeth sensitive to shock and vibration. In most cases, more then one channel is needed to accurately find an absolute position, many patents have dealt with this issue, in U.S. Pat. No. 3,222,668 a binary tree of channels were placed one inside the other, in U.S. Pat. No. 4,851,835 a sine shaped fine and coarse channels are placed one inside the other, requiring large radial space and in U.S. Pat. No. 3,238,523 the channels are placed side by side requiring large width, U.S. Pat. No. 6,788,220 used a similar fine & coarse principle. Four phase system require an excitation made of two sine or square wave signals with 90 degrees phase shift, in U.S. Pat. No. 2,461,832 an RC filter made this delay, in U.S. Pat. No. 4,238,781 four phase logic was used to generate the signal, in all the cases, this signal frequency is constant, and hence sensitive to noise on its fundamental frequency.

### SUMMARY OF THE INVENTION

Capacitive Sensors, as described in previous patents, are complicated to manufacture and sensitive to electrical noise. The proposed invention simplifies the complexity of the system to a two dimensional layout, compacts the design by the use of interlaced channels and improve the noise sensitivity by digitally encrypting the signals. The invention present 5 new subjects:
(1) The use of two dimensional (2D) transmitter and receiver plates, each with two sets of capacitor plates, where the 2 by 2 combination provide four distinctive states.
(2) The random generation excitation, were the signal spectra is flat, and not sensitive to fundamental frequencies like motors PWM noise.
(3) The interleave of several channels in the same radial area.
(4) The use of three dimensional (3D) rotor, where the structure is stiffer and the thickness can be twice modulated.
(5) The use of cross correlation geometry for an index channel, with reference to another channel.

Accordingly, it is an object of the present invention to provide an electrostatic capacity type encoder which enables the device to be designed to be smaller, simpler and cheaper to produce, less sensitive to vibration and shock, and less sensitive to electrical noise.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates the main components of a single channel rotary encoder made according to the present invention.

FIG. 2 illustrates the capacitive elements of a linear encoder in further details.

FIGS. 3a-3b illustrates the side view and the signal waveforms of the encoder of FIG. 2, fitted with a square wave modulated rotor in one primary position.

FIGS. 4a-4c illustrates the side view and the signal waveforms of the encoder of FIG. 2 where the square wave modulated rotor is in another primary positions. Also illustrated is a side view of a sensor with a sine wave modulated rotor.

FIGS. 5a-5b illustrates top and side view of a fine/coarse rotary encoder with two receive channels.

FIGS. 6a-6b illustrates a fine/coarse linear encoder, with options of one or two receive channels.

FIG. 7 illustrates the receiver section of a three channels enhancement to the encoder presented in FIG. 6.

FIG. 8 illustrates an interlaced, space saving, alternative to the two channel encoder presented in FIG. 6 with two exemplary rotor options.

FIG. 9 illustrates a rotary implementation of interlaced encoder presented in FIG. 8.

FIGS. 10a-10d illustrates the special embodiment where the second channel is used to detect a single index position, and describe the principle of the “key” autocorrelation matching mechanism.

FIG. 11 illustrates an interlaced, space saving, alternative to FIG. 10.

FIGS. 12a-12b illustrates the principle of a linear reflective sensor that requires only two components.

FIG. 13 illustrates a reflective rotary sensor.

FIGS. 14a-14b illustrates one embodiment of a random frequency excitation generator and the related waveforms.

FIG. 15 illustrates one embodiment of the signal processing units used in the encoder of FIG. 1.

FIG. 16 illustrates one embodiment of the Digital Demodulator Unit core used in the signal processing unit of FIG. 15.

FIGS. 17a-17b illustrates one embodiment and logic description of a Post Angle Processor unit used in the signal processing unit of FIG. 15.

### DETAILED DESCRIPTION OF THE INVENTION

In the following description, for purposes of explanation, specific numbers, materials and configurations are set forth in order to provide a thorough understanding of the present invention. However, it will be apparent to one skilled in the art that the present invention may be practiced without the specific details. In other instances, well known features are omitted or simplified in order not to obscure the present invention.

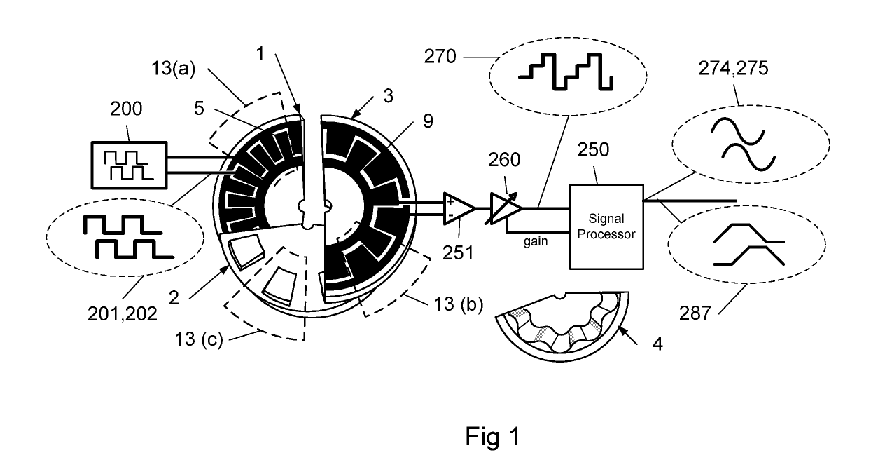

FIG. 1 illustrates the main components of the present invention single channel rotary encoder; where an excitation generator 200 generate two perpendicular square signals 201, 202 to two sets of metal transmit plates 5 printed on a single plane of a Printed Circuit Board [PCB]. Those static transmitter 1 plates, together with a rotating rotor 2 made of dielectric material, and two sets of static receiving plates 9 imprinted on the receiver 3, form the four different variable capacitors, needed to electrically detect the relative position of the rotor and the stators. The differential signal received by the receiver plates 9, is amplified by a differential amplifier 251, and further amplified by externally gain controlled amplifier 260 that provides constant signal levels. Signal Processor unit 250 demodulates the encoder signal 270. The use of a square shaped rotor 2 generate a trapezoid signal 287 at the outputs of the Signal Processor 250, an alternative use of a sine shaped rotor 4 will result with sine and cosine 274, 275 signals as known in the art and described in previous patents. For clarification, every electrical cycle made of a combination of four transmitting plates 13(a), two receiving plates 13(b) and one cycle of the rotor pattern 13(c) is enclosed in dashed section.

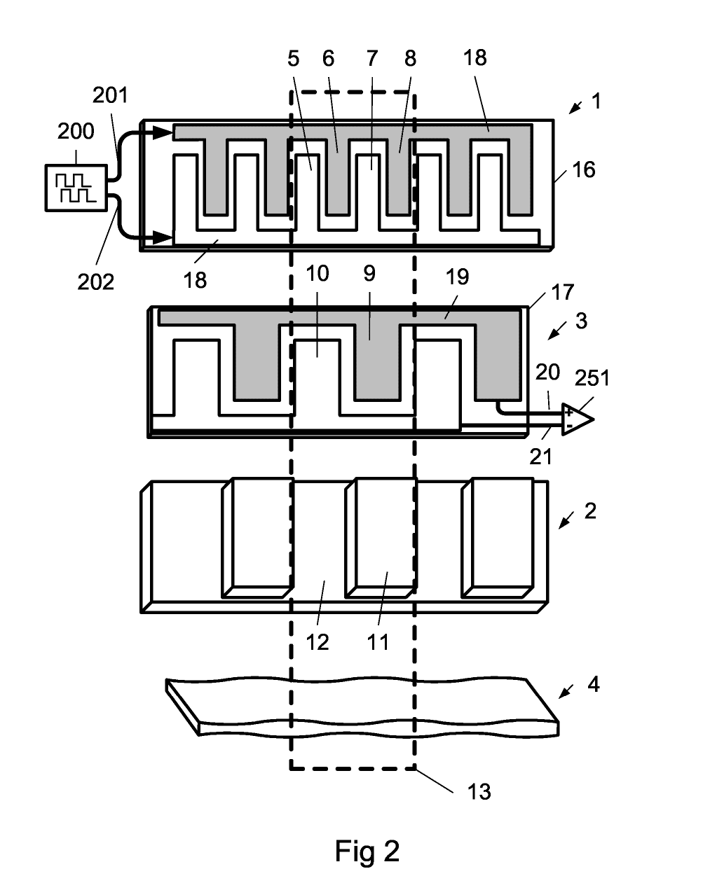

FIG. 2 illustrates the capacitive elements of a linear encoder in further details: the transmitter 1 is made of a printed circuit board where on the isolated substrate 16 two sets 5,6 of interlaced capacitor plates are fabricated, the metal patterns are made using lithographic techniques known in the art. The transmitter plates are divided into two groups, the “main” set of identical plates 5,7 connected with interconnect lines 18 and driven by one phase 202 of the excitation generator 200 and the “shifted” set 6,8 driven by the orthogonal excitation signal 201 through another interconnect line 18. The receiver 3 is made of a similar printed circuit board where on the isolated substrate 17 two sets 9, 10 of interlaced capacitor plates are fabricated, those sets are connected with interconnect lines 19 and drive a differential receiver amplifier 251. The combination of two transmit and two receive plates creates a matrix of four dependent variable capacitors, used to electrically detect the relative position of the rotor and the stator, this matrix is farther explained later. The pattern printed on the receiver and transmitter is made of two non intersecting areas that can be fabricated using planar two dimensional techniques, without the need of a third dimension “via” interconnect between different layers of the PCB. The square shaped profile rotor 2 is made of any dielectric material known in the art like polycarbonate, the thickness of the capacitor is amplitude modulated by the pattern. Moving the rotor along the transmitter and receiver results in a trapezoid shaped signal. An optional rotor 4 where the thickness is sine modulated, will generate sine and cosine outputs. For clarification, enclosed in dashed section 13, are a set of four adjacent transmitter plates 5,6,7,8 on the transmitter 1 that interacts with one set of two adjacent receiver plates 9,10 on the receiver 2 and one set of “thick” part 11 and “thin” part 12 on the rotor 2.

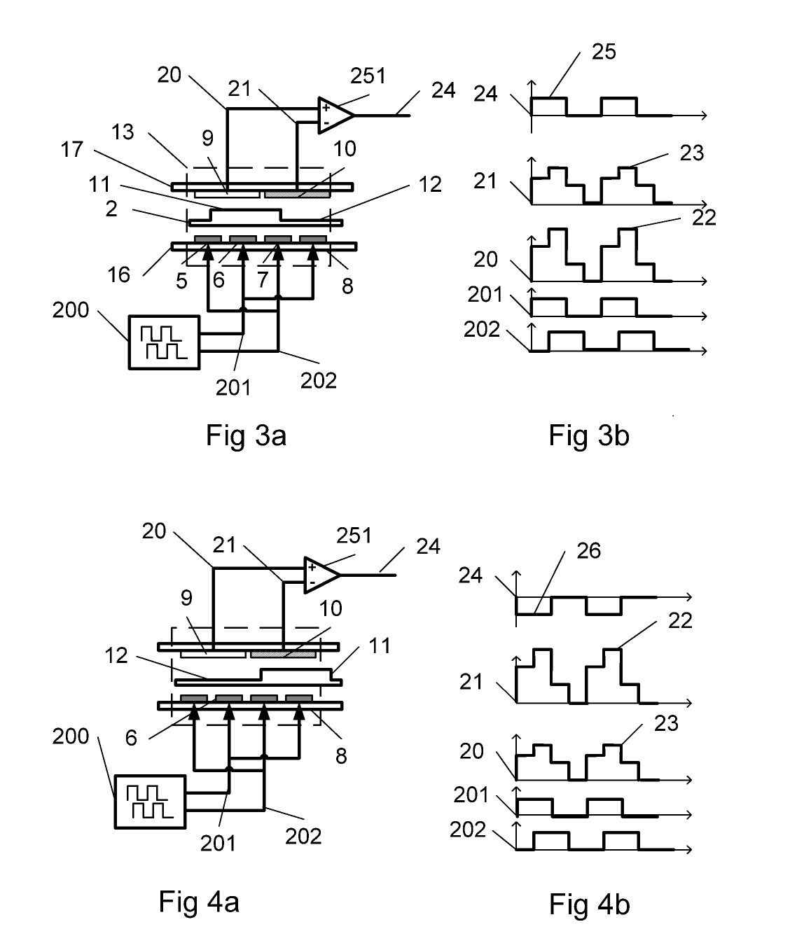

FIG. 3a illustrates one electrical cycle 13 cross section view of the encoder from FIG. 2 made of transmitting plates 5,6,7,8 driven by excitation generator 200, mounted on isolated transmitter substrate 16 facing a square wave modulated rotor 2 “thick” 11 and “thin” 12 sections. Facing the rotor are the receiver plates 9, 10 mounted on receiver isolation substrate 17, and driving the differential amplifier 251. The capacitance matrix is made of four distinct combinations of receiver and transmitter plates that resemble the four combinations of 0, 90, 180 and 270 electrical degrees:
(1) Combination of “main” transmitter plate 5 to “positive” receiver plate 9 form the first pair which is equivalent to 0 electrical degree,
(2) The inverse of this combination which is equivalent to 180 degrees, made by the pair “main” transmitter plate 7 and “negative” receiver plate 10.
(3) The “shifted” transmitter plate 6 to “positive” receiver plate 9 pair, equivalent to 90 degrees.
(4) The inverse of this combination which is equivalent to 270 degrees, made by the pair “shifted” transmitter plate 8 and “negative” receiver plate 10.

In this drawing the thick rotor part 11 is symmetrically facing the pair “shifted” transmitter plate 6 to “positive” receiver plate 9, this capacitor pair has larger capacitance compared to the opposite pair “shifted” transmitter plate 8 to “positive” receiver plate 10, the capacitances of the two other pairs are equal and the sum of them after the differential amplifier is zero. The waveform illustration of FIG. 3b, contains the two incoming excitation signals 201 202, the positive input signal 20 to the differential amplifier 251 that have a high positive peak 22, and the negative input signal 21 to the differential amplifier that have a lower positive peak 23, the output signal 24 of the differential amplifier has a positive peak 25.

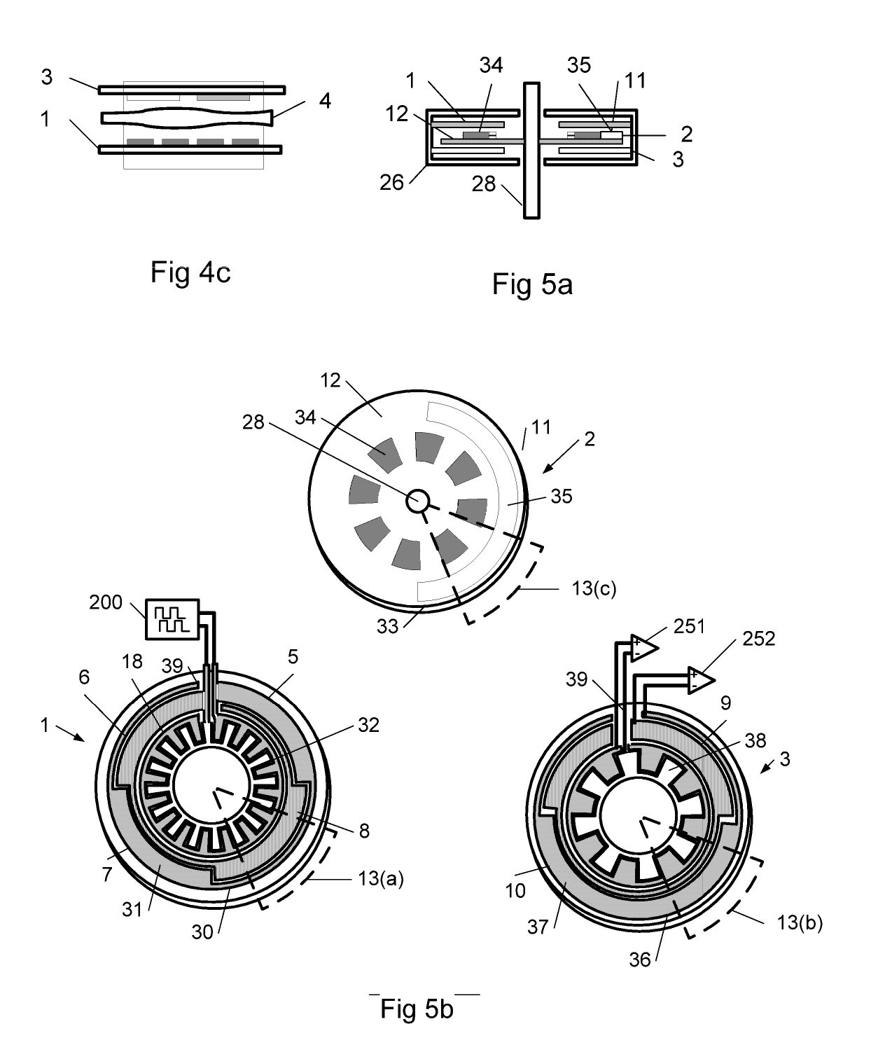

FIG. 4a illustrates the same encoder, in the mechanical position where the thick rotor part 11 is symmetrically facing the pair “shifted” transmitter plate 8 to “negative” receiver plate 10, this capacitor pair has larger capacitance compared to the opposite pair “shifted” transmitter plate 6 to “negative” receiver plate 9. As in FIG. 3a, the capacitances of the two other pairs are equal and the sum of them after the differential amplifier is zero. Shown in the waveform illustration of FIG. 4b, are the two incoming excitation signals 201 202, same as in FIG. 3b, the differential amplifier positive input signal 20 which has a low positive peak 23, and the differential amplifier negative input signal 21 which has a high positive peak 22. The output signal of the differential amplifier 24 has a negative peak 26.

FIG. 4c illustrates a side view of the encoder from FIG. 2, using sine shaped rotor 4, with the same encoder transmitter 1 and receiver 3 patterns as in FIG. 4a.

Rotary & Fine/Coarse Implementation

FIG. 5a illustrates a side view of a fine/coarse rotary encoder where box 26 holds the transmitter 1 and receiver 3 firmly in place. The rotor 2 is connected to shaft 28, on the radial axis of the encoder, the fine channel 34 thick parts are placed on the inner ring and the coarse channel 35 thick 11 and thin 12 parts are placed on the outer ring.

FIG. 5b illustrates the layout of the transmitter 1, receiver 3 and rotor 2 of a fine/coarse rotary encoder with two receive channels. The transmitter 1, has one electrical cycle outer coarse ring 31, made of four excitation plates 5,6,7,8 connected as two pairs and an inner fine ring 32 with eight electrical cycles made of thirty two excitation plates connected to two interconnect rings 18. Both fine and coarse rings are driven simultaneously from the same excitation generator 201. For clarification one set out of the eight fine electrical poles is enclosed in dashed section 13(a), The rotor 2 has two sets of thick dielectric teeth, a) A single half circle long tooth 35 for the coarse channel. b) Eight small 1/16 of circle long teeth 34 for the fine channel. All thick parts are placed on the rotor thin homogenous substrate 33 that provide the strength of the rotor, which is firmly connected to shaft 28. For clarification, a set of a single fine electrical pole is enclosed in the dashed section 13(c). The receiver 3 has two sets of receiving plates: A pair of coarse plates 37, connected to differential amplifier 252 and eight pairs of fine receive plates 38 connected to differential amplifier 251. For clarification, a receive set of a single fine electrical pole is enclosed in the dashed section 13(b). Small clearances 39 in the transmitter 31 and receiver 37 plates permit the wiring to be kept in a two dimensional structure.

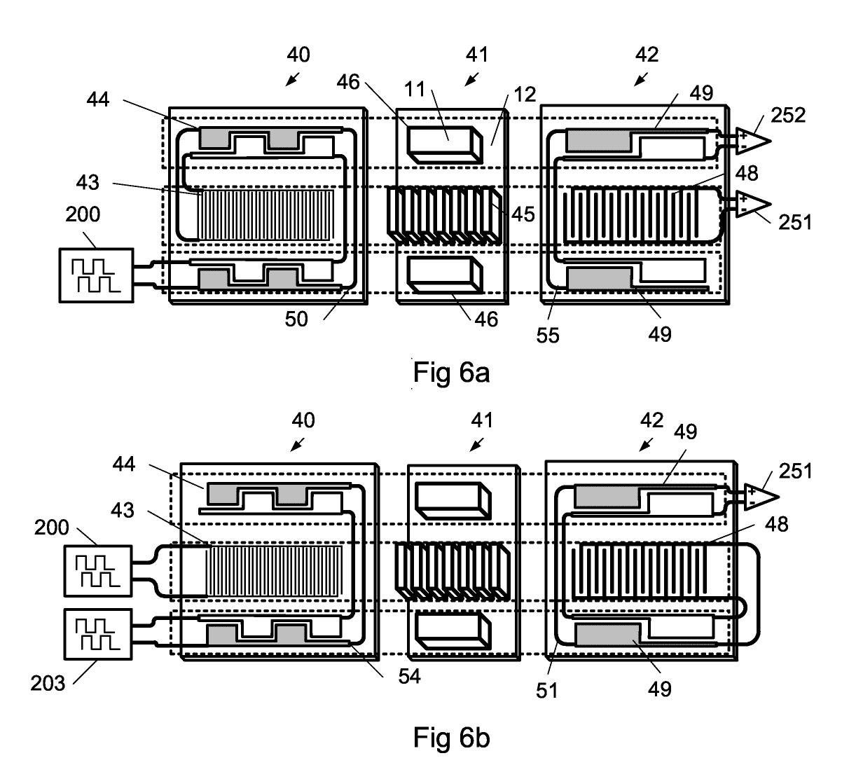

FIG. 6a illustrates a linear fine and coarse sensor made of transmitter 40, rotor 41 and receiver 42. The transmitter 40 comprises of two sets of thin transmit plates of the fine channel 43, and two symmetrical pairs of larger transmit plate sets that make the coarse channels 44, both channels are driven by the same two clock phases of the excitation generator 200. Interconnect wires 50 connect together each of the excitation sets, while maintaining the two dimensional structure. The rotor 41 has two sets of thick 11 and thin 12 parts, one fine set for the fine channel 45 and two symmetrical thick parts 46 for the coarse channel. The receiver 42, is made of two pairs of receiving elements for the fine channel 48 mating the fine channels of the rotor 45 and transmitter 43 and driving a differential amplifier 251. Two pairs of symmetrical coarse channel receiving plates 49 mating the rotor channel 46 and transmitter plates 44 are driving a second differential amplifier 252. Receiver interconnect wires 55 are used to connect together the two sets of coarse receiving plates 49 using a two dimensional layout.

FIG. 6b illustrates another embodiment of the fine/coarse encoder, where the transmitter 40 is using the same fine 43 and coarse 44 elements as FIG. 6a, however they have a different interconnect scheme 54, where the fine transmit plates are driven from one oscillators 200, and the coarse transmit plates 44 are driven from a second oscillators 203 orthogonal to the first one 200. One way of making orthogonal clocks is having one clock frequency double then the other, as known in the art. The rotor 41 is the same as in FIG. 6a. The receiver is made of the same fine 48 and coarse 49 elements as FIG. 6a; however they have a different interconnect scheme 51, where both the fine 48 and coarse 49 plate pairs drive the same differential amplifier 251. This modification requires driving more signals to the transmitter plate and the dynamic range is smaller, however it requires only one input channel and might be cost effective in some cases.

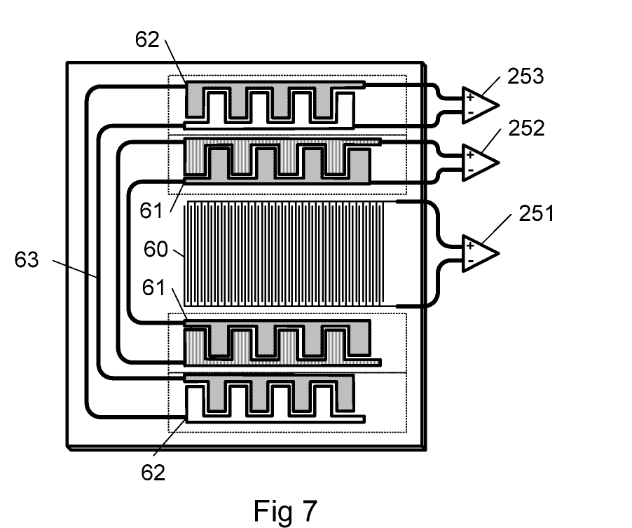

When the coarse channel resolution is not enough to distinguish between two fine cycles, a second coarse channel is added. The receiver section of a three speed unit is illustrated in FIG. 7: made of a fine channel 60, a symmetric pair of coarse1 61 channels and a symmetric pair of coarse2 62 channels driving three differential amplifiers 251, 252, 253 respectively. In this example there are eight fine segments 60 per one coarse1 cycle 61, and the fine position in one coarse cycle is found by simple divide mathematics as known in the art. To distinguish between the different coarse1 cycles 61 a second coarse2 62 with a slightly different pitch is used. For example: in FIG. 7 there is a ratio of seven coarse1 61 cycles to eight coarse2 62 cycles. Using the principle of a Vernier caliper, as known in the art, the exact coarse cycle can be found. The receiver plates are interconnected together with interconnection wires 63 on a single two dimensional plane, the rotor and transmitter are based on the same principle as the two speed sensor of FIG. 6a and need not be further explained.

Several Channels of the Same Perimeter

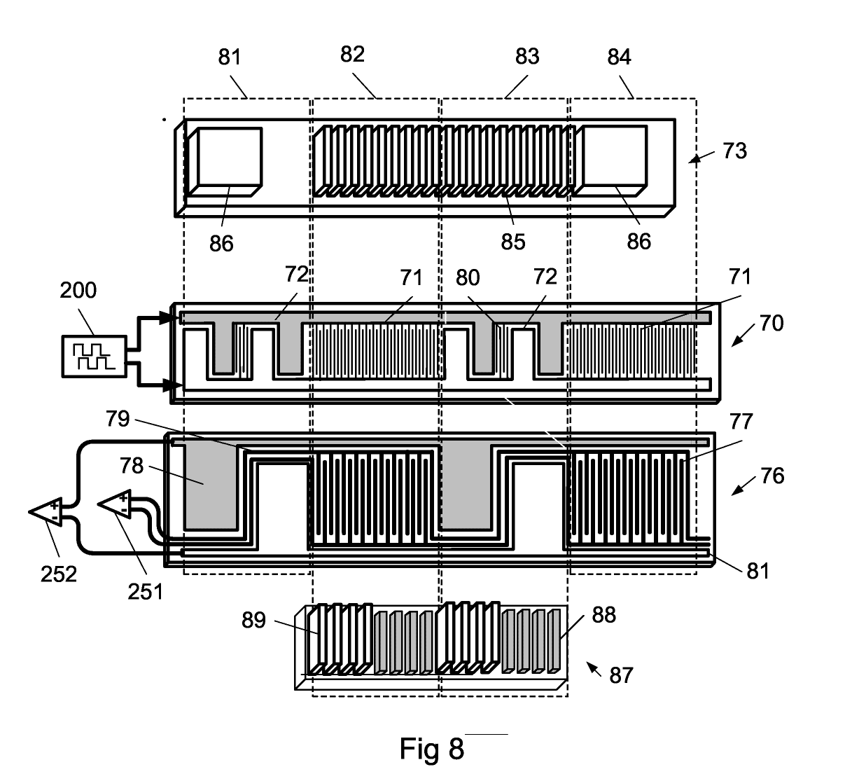

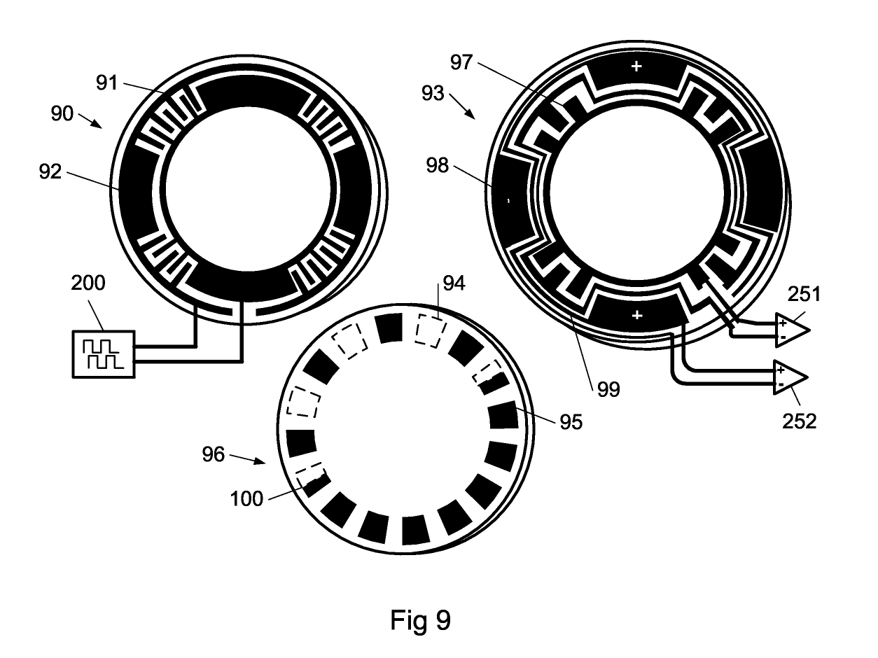

Putting several speed tracks side by side as in FIG. 6 and FIG. 7 requires a large space, FIG. 8 illustrates an interlaced, space saving, alternative to the two channel encoder presented in FIG. 6. This encoder is made of a transmitter 70; receiver 76 and one of two rotor options 73 or 87, the two different channels coarse and fine are interlaced one within the other within the same width. Half of the transmitter 70 area is made of fine transmit plates 71 and the other half is made of the coarse transmit plates 72, both are driven by the same excitation generator 200. The receiver structure 76 is similar to the transmitter, with coarse channel 78 plates connected to differential amplifier 252. The fine channel plates 77 are connected together with interconnect wires 79 that are interlaced between the coarse plates in order to achieve a two dimensional plane layout. The fine channel plates are driving differential amplifier 251. To match the interconnect wires 88 in the receiver, two more pairs of fine transmit plates 80 are placed on the transmitter 70. The rotor 73 in this example is split to fine segments 85 and coarse segments 86. The principle of operation is: The pitch of each of the rotor sections fine 85 and coarse 86, is twice that of the transmitter and receiver section fine 71,77 and coarse 72,78. Creating four possible combinations of interactions:
(1) Case marked by shaded area 81: coarse rotor segment 86 facing coarse transmit 72 and receive 78 sections, resulting in a signal proportional to the coarse channel relative position.
(2) Case marked by shaded area 82: fine rotor segment 85 facing fine transmit 71 and receive 77 sections, resulting in a signal proportional to the fine channel relative position.
(3) Case marked by shaded area 83: fine rotor segment 85 facing coarse transmit 72 and receive 78 sections, resulting zero integral of orthogonal channels.
(4) Case marked by shaded area 84: coarse rotor segment 86 facing fine transmit 71 and receive 77 sections, resulting zero integral of orthogonal channels.

Also presented in FIG. 8 is another, more energy efficient, option of a triple thickness level interlaced rotor 87, using the same transmitter 70 and receiver 76. The rotor is made of fine segment lines thickness modulated by the coarse waveform, where half of the fine lines are thinner in the coarse “thin” area 88 and thicker in the coarse “thick” area 89. The principle of operation is: As the pitch of each of the coarse modulation of the rotor is equal to the transmitter and receiver sections fine 71,77 and coarse 72,78, there are only two combinations of interactions:
(1) Case marked by shaded area 82: four fine rotor segment 89 and four half height fine rotor segment 88 facing fine transmit 71 and receive 77 sections, resulting with a signal proportional to the fine channel location.
(2) Case marked by shaded area 83: a course cycle made of four fine thick rotor segment 89 and four thin (half height) fine rotor segment 88 facing coarse Transmit 72 and receive 78 sections, resulting with a signal proportional to the coarse channel location.

FIG. 9 illustrates a rotary implementation of the interlaced encoder presented in FIG. 8, made of a transmitter 90, receiver 93 and rotor 96. Half of the transmitter board 90 perimeter is made of fine 91 segments and the other made of coarse segments 92, both driven by the same excitation generator 200. Half of the receiver 93 perimeter area is made of the coarse 98 segments driving differential amplifiers 252, and the other half by the fine segments 97 driving differential amplifier 251. Interconnect wires 99 keep the design two dimensional. The rotor 96, is made of fine thick segments 95 where half of them 94 are missing in the area defined as “thin” by the coarse cycle, in this example there are only two capacitance levels. Note that two fine segments 100 are only half fine period length, complementing each other, making the coarse cycle exactly one half of a circle. The principle of operation is similar to the one described on linear rotor 87 of FIG. 8.

Single Index Autocorrelation Generating Mechanism

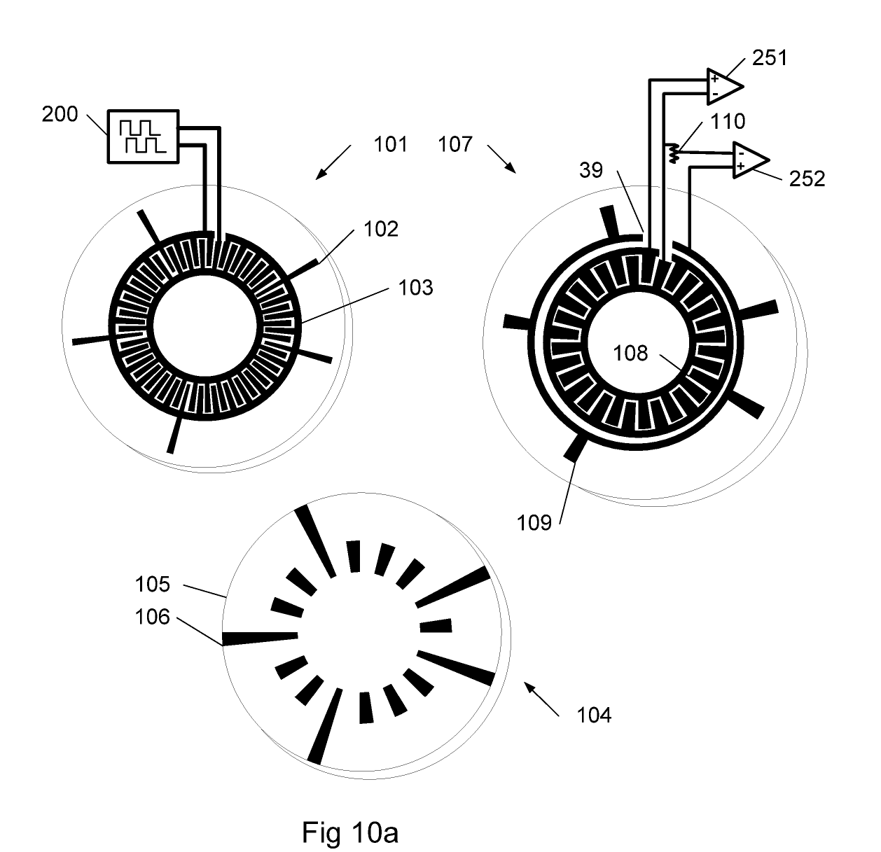

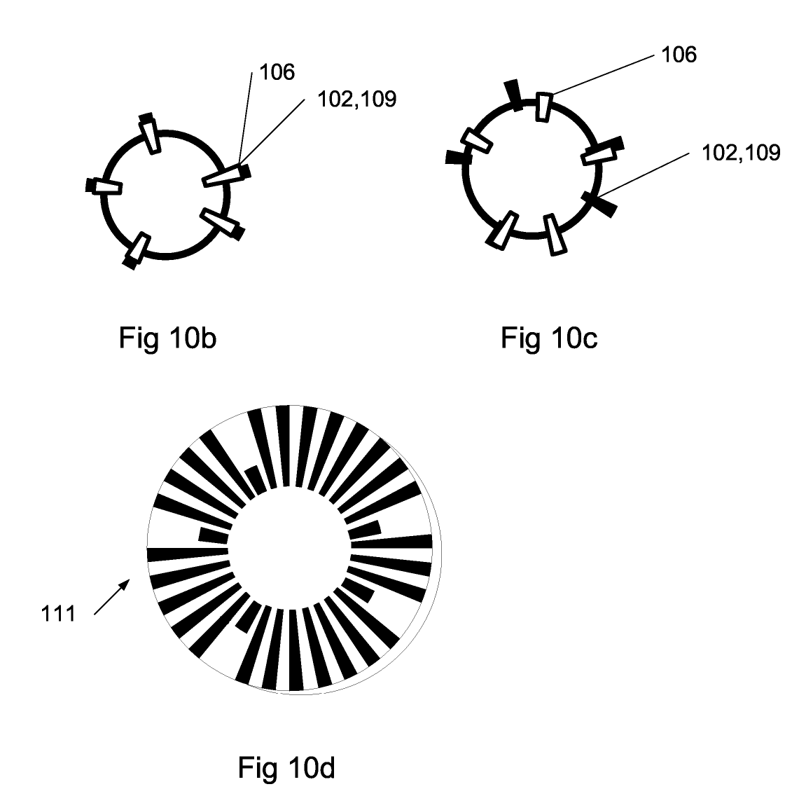

Incremental encoders require an index channel that generates an index mark only once per full rotation. As a fine channel with N poles can provide N such index marks in one full rotation, a second index channel is required to single out one position from others. FIG. 10a illustrates an enhancement of the rotary encoder of FIG. 5, made of transmitter 101, receiver 107 and rotor 104, where the coarse channel of FIG. 5 is replaced with a set of plates (five in this example) placed unevenly around the perimeter of the transmitter, receiver and rotor. The transmitter 101 have additional index channel transmit plates 102 placed externally to the fine transmitter plates 103, driven by one of the excitation generator 200 phases. On the rotor 104, some of the fine teeth 105, are made longer 106 to form the index marking. In the receiver 107, the fine channel plates 108 drive the differential amplifier 251 as in FIG. 5. An additional non differential index channel 109 is added on the perimeter driving the positive input of differential amplifier 252. This amplifier negative input is driven through a voltage divider 110 by one of the input signals from the fine channel. The divider ratio is calculated to be less then the ratio of index teeth total area to the fine teeth total area, in this example five to sixteen. To further explain the “key” principle, FIG. 10b illustrate the case where all of the index teeth 106 in the rotor, the transmitter 102 and receiver 109 are aligned, forming five capacitors and high signal strength. FIG. 10c illustrates one of the cases where they are not aligned, forming only two capacitors and lower signal strength. To achieve aligning only in one position over the rotation, the teeth are arranged with an increasing prime distance between them to both directions. In this example: two and three spaces, FIG. 10d presents an alternative negative logic rotor 111, where the signal is minimal when the rotor and stators are aligned.

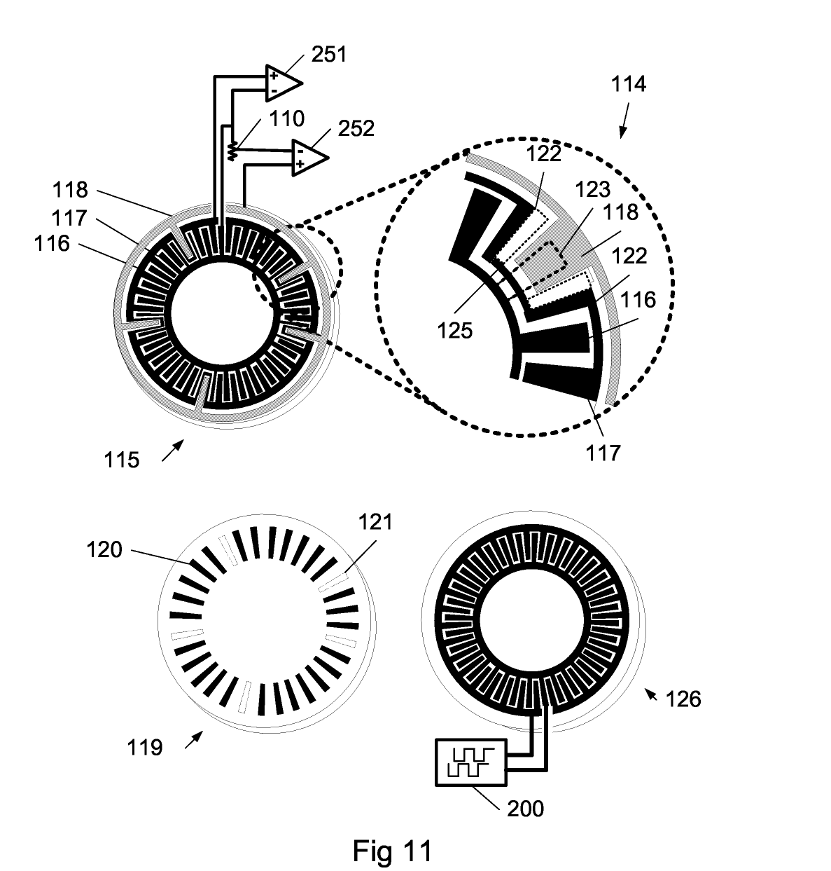

FIG. 11 illustrates an interlaced space optimization of the design presented in FIG. 10, similar to the interlacing principle presented in FIG. 9 where the two channels are interlaced on the same radial space. The symmetry of the rotor 119 is broken by removing 121 some of the fine segments 120, in the receiver 115 a third channel 118 is added and interlaced in the same perimeter with the two existing fine sets of plates 116 & 117, the enlargement view 114 illustrate the index receive plate 118 replacing a fine pair made of one positive fine receiver plate 123, and two halves of two negative plates 122. Interconnect wire 125 maintain the connectivity of the negative receiver channel 117; The fine channel plates 116, 117 drive differential amplifier 251. Differential amplifier 252 is driven by the non differential index channel and by one of the fine channels through voltage divider 110, in a similar configuration to FIG. 10. The transmitter 126 has the trivial set of one transmit channel pairs.

Reflective Capacitor Structure

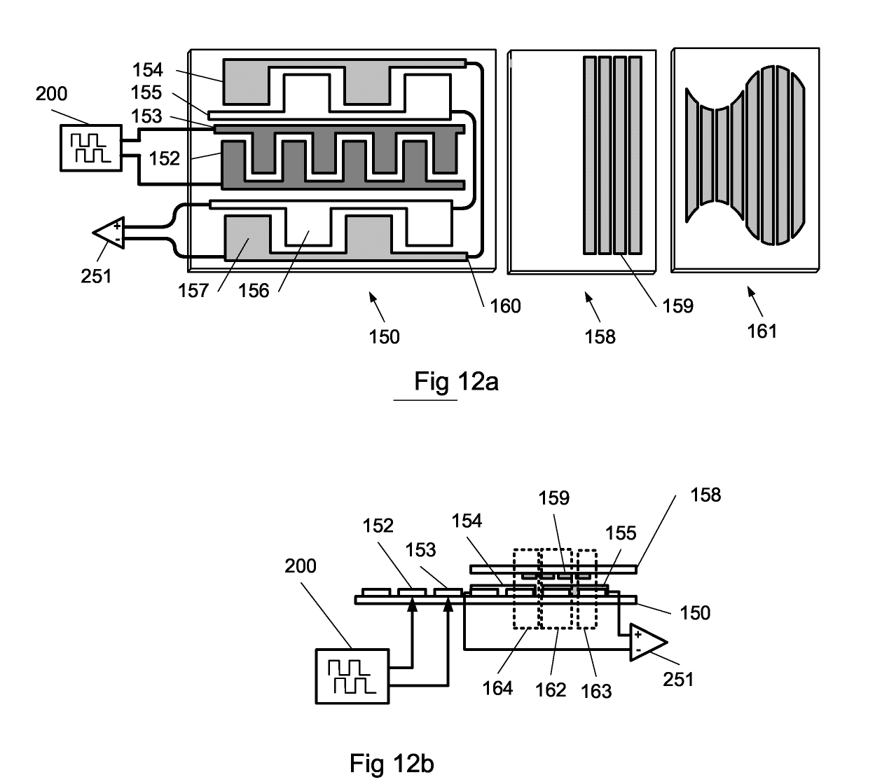

FIG. 12a illustrates the principle of a linear reflective sensor that requires only two components: transceiver 150 and rotor 158. The transceiver 150 is made of two transmitting pairs of plates 152 and 153 driven by oscillator 200 and two symmetrical sets of receiver plate pairs: (154, 155) and (156, 157) connected with interconnect wires 160 on a two dimensional plane to differential amplifier 251. Half of the rotor area is covered with conductive segments 159 that according to the position, couple the transmit plates to the positive 155, 156 set of receive plates, to the negative 154, 157 set of receive plates or to a combination of both. This square shaped rotor generates a trapezoid wave vs. position. An alternative sine shaped rotor 161 can be used to achieve sine and cosine outputs.

FIG. 12b illustrates a side view of the sensor; where:
(1) Case marked by shaded area 162: Two sections of the rotor conductive segments 159 are facing the “main” 152 transmit plate and the positive receive plate 155.
(2) Case marked by shaded area 163: One section of the rotor conductive segments 159 face the combination of the “shifted” 153 transmit plate and positive receive plate 155.
(3) Case marked by shaded area 164: One section of the rotor conductive segments 159 face the combination of the “shifted” 153 transmit plate and negative receive plate 154.
   The sum of the last two signals 163 164 is zero. To prevent cross talk between the two transmit channels 152, 153. The rotor conductive segments 159 are made as thin stripes, so every stripe faces only one of the transmit plates.

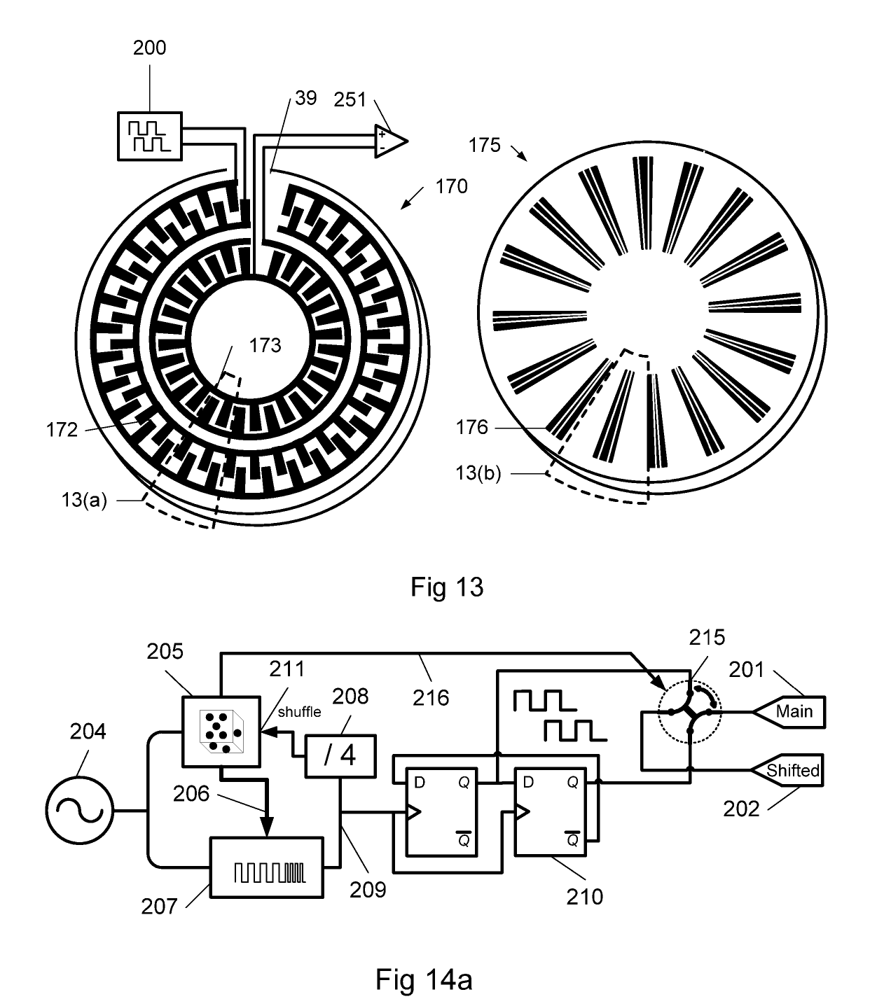

FIG. 13 illustrates a reflective rotary sensor that requires only two parts: transceiver 170 and rotor 175. The transceiver 170, is made of two sets of transmitting plate pairs 172 driven by excitation generator 200 and two sets of positive and negative receiver plates 173 driving a differential amplifier 251, On the rotor 175 there are reflective segments 176, that creates a capacitance between the transmit and receive plates. For clarification, enclosed in dashed section 13(a) are a set of two pairs of transmit plates 172 and one pair of receive plates 173 on the transceiver 170 that interacts with one segment 176 of the rotor 175 enclosed in dashed section 13(b).

Random Waveform Excitation Mechanism

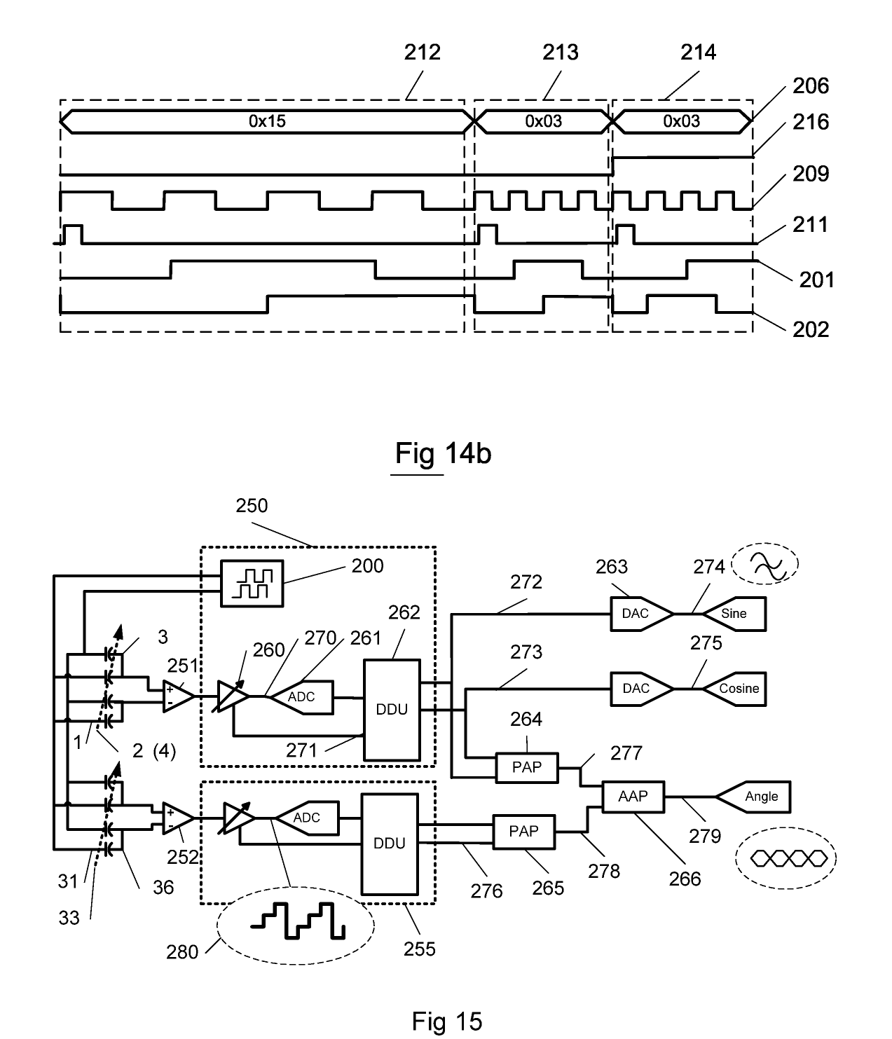

Previous designs had a constant excitation frequency that was sensitive to external electric noise harmonics at this frequency; FIG. 14a illustrates one embodiment of the random frequency excitation generator 201, creating two orthogonal clock signals “main” 201 and “shifted” 202, used to drive the transmitter excitation plates. The random frequency excitation generator is made of a random number generator 205 digitally configuring a clock generator 207, a two bit gray counter 210, and a switch 215 that can swap between the two outputs. After every set of four clocks, counted by frequency divider 208, the random clock generator 205 “shuffle” and generate a new random clock length word 206 to the configurable clock generator 207. The two bit gray counter 210 generates two orthogonal clock signals out of every four clock 209 cycles using two D-FF as known in the art. Another random bit 216 generated by the random clock generator 205 randomly commands the switch 215 to alternate between the two channels so half the times the “main” 201 leads the “shifted” 202 (case 213 of FIG. 14b) and on the other half, the “shifted” 202 leads the “main” 201 (case 214 of FIG. 14b).

FIG. 14b illustrates three examples of the waveforms generated by the random frequency excitation generator of FIG. 14a :
(1) On the first cycle 212 the clock length word 206 is 0×15 and polarity bit 216 is reset, four relatively slow phases are generated and the “main” 201 leads the “shifted” 202 clock.
(2) After a shuffle 211 tick, on the second cycle 213, the clock length word 106 is 0×03 and polarity bit 216 is reset. Four relatively fast phases are generated and the “main” 201 leads the “shifted” 202 clock.
(3) After another shuffle 211 tick, a third cycle 214 with clock length word 106 set again to 0×03 but with polarity bit 216 set, four similar relatively fast phases are generated with the “shifted” 202 leads the “main” 201 clock.
   Signal Processing

FIG. 15 illustrates one embodiment of the signal processing units used in the encoder of FIG. 1: where the excitation generator 200 is driving the transmitter fine 1 and coarse 31 capacitor plates, forming two variable capacitors a) Fine: using either a square rotor 2 or a sine shaped rotor 4, and receiver plates 3. b) Coarse using rotor 33 and receiver plates 36. The fine receiver capacitor plates 3 are driving the signal processing unit 250 through differential input amplifier 251, the four levels signal is amplified to a constant amplitude range signal 270 using a digital variable gain controlled amplifier 260. The Analog to Digital Converter [ADC] 261 convert the input signal to digital format, processed by the Digital Demodulator Unit [DDU] 262, that in case that a sine patterned rotor 4 is used, creates sine 272 and cosine 273 digital words. The two words are converted by Digital to Analog Converters [DAC] 263 to analog signals 274 & 275. Optionally, in the case that a square patterned rotor 2 is used, the same DDU 262 trapezoid shaped output words 272 & 273 are referred as “S” & “C”. A suitable Analog to Digital Converter 261 includes AD7450 12 bit ADC manufactured by Analog Devices, of Norwood, Mass. A suitable DAC 263, include AD5446 14 bit DAC manufactured by Analog Devices, of Norwood, Mass., The core of DDU circuit 262 is made as VHDL code in a programmable FPGA including Cyclone manufactured by Altera Corporation of San Jose, Calif. or as software written in a programmable processor including the C8051F002 CPU made by Silicon Laboratories of Austin, Tex. or as part of custom made ASIC. A suitable variable gain controlled amplifier 260 is made of a DAC8043A multiplying DAC manufactured by Analog Devices, of Norwood, Mass., configured as a feedback to an operational amplifier known in the art. The Coarse receiver capacitor plates 36 are driving a similar signal processing unit 255 through input amplifier 252. An optional Post Angle Processor [PAP] 264 convert the two fine orthogonal “S” 272 & “C” 273 digital words to a digital fine angle 277. A similar PAP unit 265, convert the two coarse 276 digital words to a digital coarse angle 278. an Absolute Angle Processor [AAP] 266 generate an absolute position 279 out of those two digital words, using fine and coarse absolute position finding algorithms known in the art.

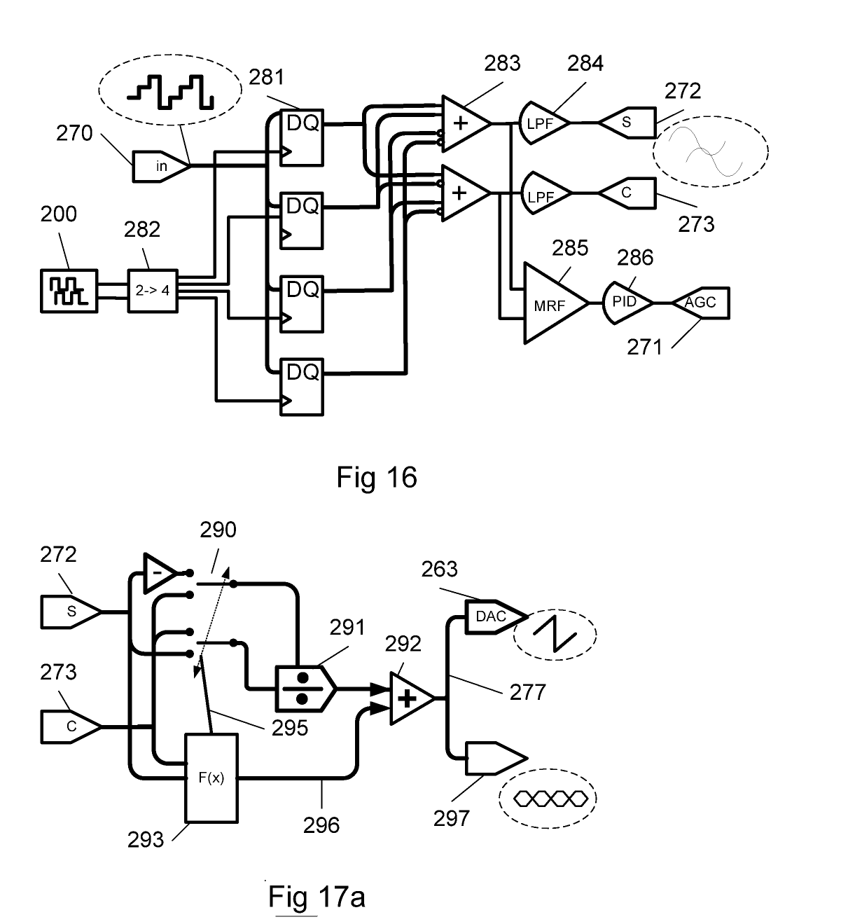

FIG. 16 illustrates one embodiment of the Digital Demodulator Unit core used in the signal processing unit of FIG. 15. Each of the four signal levels of the input signal 270, representing one of the four combinations of the two excitation 200 phases {(S+C), (S−C), (−S−C), (−S+C)}, is latched by one of the four latches 281 synchronized to the four states of excitation generator 200 using a 2to=b 4 de-multiplexer 282. Those four levels are added/subtracted by adders 283 to decode out of them the sine and cosine signals. Digital low pass filters 284 filter the signal and limit the bandwidth as known in the art. The Automatic Gain Control digital command 271, is generated by a PID filter 286 that compares a Maximum Range Function [MRF] 285 of the two signals 272, 273 amplitude to a reference value, and the result 271 of the PID mechanism 286 calculation drive the digital variable gain controlled amplifier 260 of FIG. 15, The design of a PID controller is commonly known in the art. The implementation of the Maximum Range Function [MRF] 286 is dependent of the rotor structure; a) Sum of squares of the sine 274 and cosine 275 signals generated using a sine shaped rotor 4. b) MAX function for “S”264 and “C” 265 signals generated using a square shaped rotor 2. The implementation of comparator, multiplier and adder are known in the art.

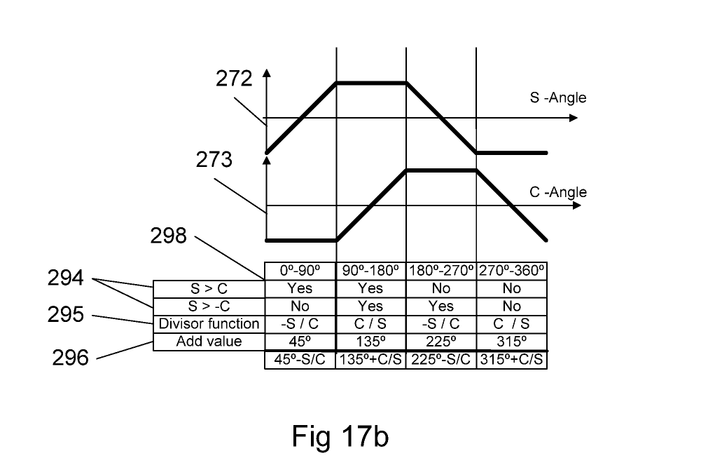

FIG. 17a illustrates one embodiment of a Post Angle Processor [PAP] used in the signal processing unit of FIG. 15 to generate a fine digital angle 277 out of the “S” 272 & “C” 273 signals, requiring a square shaped rotor 2. The logic 293 compare the “S” & “C” signals and decide to swap 295 the signals “S” and “C” using switch 290 so the smaller signal is the nominator and the larger one the denominator of the divider 291, the logic also defines if it is needed to invert the “S” signal in two of the cases. The division result is added to the center angle 296 of the quarter of a circle selected by the logic 293. This signal can be converted to a potentiometer style analog value using DAC 263 or transmitted to an external computer via a communication link 297, both known in the art.

FIG. 17b illustrates the waveform of the two signals S 272 & C 273 and a mating look up table 298 implementation of the logic 293. The table has one colon per circle quadrant and one row per logic function. To detect the quadrant, two inequalities 294 are tested to define the quadrant, a) if (“S”>“C”) and b) if (“S”>−“C”), generating two commands: A command 295 to switch 290 and a center angle value selection 296, added by adder 292 to form the center angle for the specific quadrant. The implementation of comparator, divider and adder are known in the art.

Thus, a method and apparatus for two dimensional layout, space saving interlaced channels with high noise immunity electric capacitive sensor has been described. While the methods and apparatus of the present invention have been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. An electrostatic capacity type encoder comprising:
a) A plurality of first stationary transmitter comprising of two transmitting electrodes to which alternating currents from a source of electrical power with respective different phases are applied
b) A plurality of second stationary receiver comprising of two mating sets of receive electrodes for receiving said signals
c) A moving disk or plate with varying dielectric characteristics facing said transmitting & receiver electrodes, with non uniform pattern, either by distance, thickness, material, geometry or combination of them.

2. The electrostatic capacity type as set forth in claim 1, wherein
a) The first stationary transmitter comprising of two transmitting electrodes and second stationary receiver comprising of two mating sets of receive electrodes are provided on the same side of said one stationary disk
b) A moving disk or plate with non uniform conductive pattern, facing and forming capacitors with the said transmitting & receiver electrodes.

3. The electrostatic capacity type as set forth in claim 1, wherein
A moving receiver made of two sets of receive plates for receiving said signal provided from a plurality of first stationary transmitter comprising of two transmitting electrodes to which alternating currents from a source of electrical power with respective different phases are applied.

4. The electrostatic capacity type as set forth in claim 1, wherein
A stationary receiver made of two sets of receive plates for receiving said signal provided from a plurality of first moving transmitter comprising of two transmitting electrodes to which alternating currents from a source of electrical power with respective different phases are applied.

5. An electrostatic capacity type encoder comprising:
a) A plurality of first stationary transmitter to which alternating currents from a source of electrical power with respective different phases are applied
b) A plurality of second stationary receiver for receiving said signals
c) A moving disk or plate with varying dielectric characteristics facing said transmitting & receiver electrodes, either by distance, thickness, material, geometry or combination of them
d) An excitation signal for an electrostatic capacity type encoder comprising of a variable duration generator of the excitation signals.

6. The variable duration generator excitation mechanism as set forth in claim 5, wherein the signals order is randomly swapped.

7. The electrostatic capacity type encoder as set forth in claim 5, wherein
a) The first stationary transmitter and second stationary receiver are provided on the same side of said one stationary disk
b) A moving disk or plate with non uniform conductive pattern, facing and forming capacitors with the said transmitting & receiver electrodes.

8. The electrostatic capacity type encoder as set forth in claim 6, wherein
a) The first stationary transmitter and second stationary receiver are provided on the same side of said one stationary disk
b) A moving disk or plate with conductive pattern, facing and forming capacitors with the said transmitting & receiver electrodes.

9. An electrostatic capacity type encoder comprising:
a) A plurality of first stationary transmitter with two or more interlaced transmit patterns of two or more different pattern cycle (e.g. fine and coarse)
b) A plurality of second stationary receiver with two or more interlaced receive patterns of two or more different pattern cycle for receiving said signal
c) A moving disk or plate with two or more interlaced varying dielectric characteristics facing said transmitting & receiver electrodes, either by distance, thickness, material, geometry or combination of them.

10. The electrostatic capacity type as set forth in claim 9, wherein
a) The first stationary interlaced transmitter and second stationary interlaced receiver are provided on the same side of said one stationary disk
b) A moving disk or plate with conductive pattern, facing and forming capacitors with the said transmitting & receiver electrodes.

11. The electrostatic capacity type as set forth in claim 9, wherein
A moving receiver made of two or more interlaced sets of receive plates for receiving said signal provided from a plurality of first stationary interlaced transmitter.

12. The electrostatic capacity type as set forth in claim 9, wherein
A stationary receiver made of two or more interlaced sets of receive plates for receiving said signal provided from a plurality of first moving interlaced transmitter.

13. The electrostatic capacity type as set forth in claim 9, wherein
a) A moving disk or plate with two or more interlaced varying dielectric characteristics arranged in three or more levels of capacitances, based on different area, thickness, material, geometry or combination of them.

14. The electrostatic capacity type as set forth in claim 10, wherein
a) A moving disk or plate with two or more interlaced varying reflective characteristics arranged in three or more levels of capacitances, based on different area.

15. The electrostatic capacity type as set forth in claim 9, wherein
a) One of the interlaced channels is non differential
b) An electronic circuit implementing comparison of signal amplitude is made to fraction of another reference channel signal of different geometry and capacitance characteristics.

16. An electrostatic capacity type encoder as set forth in claim 10, wherein
a) One of the interlaced channels is non differential
b) An electronic circuit implementing comparison of signal amplitude is made to fraction of another reference channel signal of different geometry and capacitance characteristics.
